(19) United States
(12) Patent Application Publication
(10) Pub. No.: US 2015/0322314 A1
(43) Pub. Date: Nov. 12, 2015

(54) Moisture-Curing Polyurethane Composition Comprising Sustainably Produced Raw Materials

(71) Applicant: Henkel AG & Co. KgaA, Duesseldorf (DE)

(72) Inventors: Uwe Franken, Dormagen (DE); Karin Jonscher, Duesseldorf (DE)

(21) Appl. No.: 14/805,909

(22) Filed: Jul. 22, 2015

Related U.S. Application Data
(63) Continuation of application No. PCT/EP2014/051418, filed on Jan. 24, 2014.

(30) Foreign Application Priority Data
Jan. 25, 2013 (DE) 10 2013 201 210.1

(51) Int. Cl. C09J 175/08; C08K 5/357; C09J 175/06; C08K 5/11

(52) U.S. Cl. CPC C09J 175/08; C08K 5/11; C08K 5/357; C09J 175/06

(57) ABSTRACT

Solvent-free moisture-curing polyurethane compositions are described, containing 99.9% to 75% by weight of at least one polyurethane prepolymer having free isocyanate groups, prepared by reaction of at least one polyol, selected from the group of the polyether polyols and polyester polyols, with at least one polyisocyanate in stoichiometric excess, at least one polyol being a recycled polyethylene terephthalate polyol. In addition, this composition contains 0.1% to 25% by weight of at least one additive selected from the group of the catalysts, resins, plasticisers, fillers, pigments, stabilisers, adhesion promoters and further polymers. The sum total of the aforementioned constituents is 100% by weight. These compositions can be used as a one-component adhesive, reactive hot-melt adhesive, coating material or sealant.

The invention relates to cross-linking, solvent-free, moisture-curing polyurethane compositions on the basis of polyurethane prepolymer with free isocyanate groups, produced by reacting at least one polyol from the group of the polyether polyols, polyester polyols and the mixtures thereof with at least one polyisocyanate in a stoichiometric excess, and the use thereof in one-component adhesives, reactive hot-melt adhesives, coating materials or sealants.

Solvent-free moisture-curing polyurethane compositions of the above-mentioned type and the use thereof are generally known. Usually, polyols on the basis of petrochemical raw materials are used for the synthesis of these polyurethane compositions.

Since the supply of fossil and petrochemical raw materials is finite, it is desirable in order to save those resources to substitute at least part of these polyols with sustainably produced products. The use of polyols produced from renewable raw materials is already known. Thus, polyols obtained by transesterification of native oils and fats or naturally occurring oils with triglycerides containing OH groups have already been used for a long time for certain adhesive formulations.

Thus, DE 44 01 572 A1 describes two-component polyurethane adhesives on the basis of an isocyanate component and a polyol component, which, apart from an oleochemical polyol, contain 2 to 7% by weight, in relation to the oleochemical polyol, of at least one di- and/or trifunctional alcohol, and wherein the hydroxyl value of the alcohols or the mixtures thereof is 1100 to 1850. These compositions may be used for gluing rigid or flexible substrates, in particular plastics, metals, glass or particularly preferably wood, both for combinations of these substrates with each other and for gluing these substrates to themselves.

WO2002/066572 Al also describes a polyurethane adhesive that is based on a polyol component A of 10 to 98% by weight of at least one oleochemical polyol, 1 to 7.5% by weight of at least one diol with a hydroxyl value of 400 to 2000, and 1 to 7.5% by weight of at least one tri-, tetra- or penta-functional polyol with a hydroxyl value of 200 to 2000, and a polyisocyanate component B). The NCO/OH ratio of components A and B) should be in a range of 1.5 to 0.9. The addition of 0 to 60% by weight, in relation to the overall polyol mixture, of a homogenously dissolved resin to the polyol component should effect a great increase in adhesive strength that will substantially not decrease even after 24 hours of boiling and 7 days of drying at 60° C. The adhesive is suitable for load-bearing components made from wood.

WO 2009/080740 A1 discloses a two-component polyurethane adhesive consisting of a polyol component containing 2 to 30% by weight of at least one polyester diol with a molecular weight of more than 1000 g/mol, 5 to 35% by weight of at least one 3- to 14-functional polyol, 5 to 35% by weight of hydrophobic polyols, 2 to 65% by weight of further additives or auxiliary materials, wherein the sum should be 100%, as well as a cross-linking component of polyisocyanates at an NCO/OH ratio of 0.9:1 to 1.5:1, wherein the cross-linked adhesive has a glass transition temperature (Tg) of more than 50° C.

EP2468789 A1 describes two-component polyurethane compositions comprising castor oil, at least one alkoxylated aromatic diol, at least one polyol with 5 to 8 hydroxyl groups as well as least one polyisocyanate. It is stated that these compositions should have a long “open time” and that they should still be able to be glued after a longer period of exposure to a climate with high humidity (e.g. 70% of relative humidity) even after 40 minutes, in particular even after 60 minutes, and to be cured to form polymers with a high mechanical strength, so that a structural bonding is produced. These two-component polyurethane compositions should in particular be suitable for use as structural adhesives, in particular for gluing wing half shells of rotor blades for wind turbines.

WO 2007/027921 A1 discloses solvent-free aqueous polyurethane dispersions for producing coatings that are characterised by a high hardness. For producing the polyurethane dispersions, recycled PET polyol may be used.

US 2010/0273939 A1 discloses aqueous polyurethane dispersions on the basis of aliphatic isocyanates, which form hard coatings and are characterised by a high solvent resistance. The enhanced properties are achieved by using 1 to 8% by weight of a highly functional polyol in the polyol formulation used for producing the dispersion.

U.S. Pat. No. 5,319,008 A describes a moisture-curing, substantially solvent-free and anhydrous mixture of a bituminous material and a liquid prepolymer. The prepolymer may be a polyurethane prepolymer that is for example based on recycled PET.

As has been shown above by way of example, oleochemical polyols of renewable raw materials such as castor oil, castor oil derivatives as well as transesterification products from other natural oils, e.g. soya oil, for polyurethane adhesives are prior art and are used on a large scale. Such oleochemical products are available for example under the trade names Sovermol or Renuva from BASF or Dow. What all of these polyols have in common is that they have a functionality distribution of the OH group which as a rule is unequal to 2. As a result, these polyols can only be conditionally used in one-component PU prepolymers because these can lead to unstable one-component polyurethane prepolymers due to their unfavourable distribution of the OH functionality. This manifests itself, for example, in one-component polyurethane hot-melt adhesives, in a rapid increase in viscosity during processing or, in one-component adhesives and sealants, in a very limited storage stability. Thus, these polyols on the basis of renewable raw materials cannot, or only to a very limited degree, be used for one-component polyurethane adhesives.

A further sustainable source of raw materials is the use of recycling materials, in particular recycled plastics. However, these are mostly present as an undefined granulate, they have fluctuating qualities and impurities. A further disadvantage is that they can only be incorporated into the polyurethane prepolymers as a “filler” and are not part of the prepolymer.

An exception is the so-called recycled PET (polyethylene terephthalate). This is produced from PET granulate by transesterification with diols, e.g. diethylene glycol, and contains terminal OH groups. Such polyols have been commercially available for some time with various OH numbers and/or molecular weights.

U.S. Pat. No. 4,469,824 teaches that terephthalic acid ester waste can be transferred into a liquid product. To this end, the waste or recycled polyethylene terephthalate (PET) is reacted with diethylene glycol and one or more oxyalkylene glycols, and part of the remaining ethylene glycol is removed. The ratio of the glycols to the PET waste should be greater than 1.2:1, so that any diesters present will not be separated from the solution. The liquid terephthalic acid esters thus obtained may be used as a polyol extender component in polyisocyanurate foams.

WO 2006/080743 A1 describes a method for producing polyols, polyurethanes and polyurethane foams. To this end, a polyvalent alcohol is initially reacted with a polymeric acid (unsaturated polymeric fatty acid). This reaction product is used for the depolymerisation of polyesters, polyamides and polyurethanes. Subsequently, the depolymerisation product is reacted with polyacids, polyvalent alcohols and amines in such a way that a product having an acid number of 0.5-1 mg KOH/g, an OH number of 10-500 mg KOH/g and an amine number of 1-50 mg KOH/g is obtained. The latter should have a good compatibility with polyether polyols and a good reactivity with isocyanates. The production of foams, synthetic leather and polymeric wood are possible applications.

From JP 2002-003815, a method for producing a polyurethane adhesive using recycled polyethylene terephthalate is known. To this end, the regenerated polyester polyol should be reacted with an organic diisocyanate, optionally under a chain extension reaction and using low molecular weight compounds containing active hydrogen, so that an adhesive containing a polyurethane resin is obtained. This document does not disclose any solvent-free, moisture-curing polyurethane compositions on the basis of polyurethane prepolymers with free isocyanate groups.

It is therefore the object of the present invention to also provide approaches for the production of solvent-free, moisture-curing polyurethane compositions on the basis of polyurethane prepolymers with free isocyanate groups, in which at least part of the polyols used are sustainably produced products.

The solution, according to the invention, to the problem can be found in the patent claims.

It substantially consists in providing a solvent-free, moisture-curing polyurethane composition, which composition contains 99.9 to 75% by weight of at least one polyurethane prepolymer with free isocyanate groups, prepared by reacting at least one polyol from the group of polyether polyols, polyester polyols and the mixtures thereof with at least one polyisocyanate in a stoichiometric excess, wherein at least one polyol is a recycled polyethylene terephthalate (PET). Further, this composition contains 0.1 to 25% by weight of at least one additive from the group of catalysts, resins, plasticisers, fillers, pigments, stabilisers or adhesion promoters and further polymers. The sum of the above-mentioned constituents amounts to 100% by weight.

A further subject matter of the invention is the use of the above-mentioned polyurethane composition for producing one-component adhesives, reactive hot-melt adhesives, coating materials or sealants.

As polyether polyols, reaction products of low molecular weight polyfunctional alcohols with alkylene oxides are particularly suitable. The alkylene oxides preferably have 2 to 4 C atoms. Suitable are for example the reaction products of ethylene glycol, propylene glycol, the isomeric butane diols, hexane diols or 4,4′-dihydroxy-diphenylpropane with ethylene oxide, propylene oxide, butylene oxide or mixtures of two or more thereof. Further, the reaction products of polyfunctional alcohols, such as glycerine, trimethylolethane or trimethylolpropane, pentaerythrite or sugar alcohols with said alkylene oxides to form polyether polyols are also suitable. Further polyols suitable within the scope of the invention are obtained by polymerising tetrahydrofuran (poly-THF). These polyether polyols are prepared in a manner known to a person skilled in the art and are commercially available.

Amongst the polyether polyols mentioned, the reaction products of low molecular weight alcohols with propylene oxide under conditions, under which partially secondary hydroxyl groups are formed, are particularly suitable.

For example, suitable are polyether polyols with a molecular weight of 200 to 5000 g/mol, preferably 400 to 4000 g/mol (number average molecular weight MN, measured via GPC according to DIN 55672-1:2007-08). This corresponds to hydroxyl numbers (OH numbers, determined according to DIN 53240-2:2007-11) of 560 to 22 mg KOH/g, preferably 280 to 28 mg KOH/g in the case of difunctional polyether polyols. Preferred polyols should have 2 or 3 OH groups per molecule, particularly suitable are diols with hydroxyl numbers between 20 and 500 mg KOH/g.

In a particular embodiment, no polyether polyols are used.

Further, polyester polyols are suitable. Such polyester polyols preferably comprise the reaction products of polyfunctional, preferably difunctional, alcohols, optionally together with small amounts of trifunctional alcohols, and polyfunctional, preferably difunctional and/or trifunctional, carboxylic acids. Instead of free polycarboxylic acids, the corresponding polycarboxylic acid anhydrides or corresponding polycarboxylic acid esters with alcohols with preferably 1 to 3 C atoms may also be used. Suitable for the production of such polyester polyols are in particular hexane diol, butane diol, propane diol, ethylene glycol, 1,4-hydroxymethyl cyclohexane, 2-methyl-1,3-propane diol, triethylene glycol, tetraethylene glycol, polyethylene glycol, dipropylene glycol, polypropylene glycol, dibutylene glycol and mixtures of such alcohols.

The polyester polyols to be used according to the invention preferably comprise the reaction products of polyfunctional, preferably difunctional, alcohols, optionally together with small amounts of trifunctional alcohols and polyfunctional, preferably difunctional and/or trifunctional, carboxylic acids. Instead of free polycarboxylic acids, the corresponding polycarboxylic acid anhydrides or corresponding polycarboxylic acid esters with alcohols with preferably 1 to 3 C atoms may also be used.

Suitable for the production of such polyester polyols are in particular hexane diol, butane diol, propane diol, ethylene glycol, 1,4-hydroxymethyl cyclohexane, 2-methyl-1,3-propane diol, triethylene glycol, tetraethylene glycol, polyethylene glycol, dipropylene glycol, polypropylene glycol, dibutylene glycol and mixtures of such alcohols.

The polycarboxylic acids may be aliphatic, cycloaliphatic, aromatic or heterocyclic or both. They may optionally be substituted, for example, with alkyl groups, alkenyl groups, ether groups or halogens. Suitable as polycarboxylic acids are for example succinic acid, adipic acid, suberic acid, azelaic acid, sebacic acid, phthalic acid, isophthalic acid, terephthalic acid, trimellitic acid, phthalic acid anhydride, tetrahydrophthalic acid anhydride, hexahydrophthalic acid anhydride, glutaric acid anhydride, maleic acid, maleic acid anhydride, fumaric acid, dimer fatty acid or trimer fatty acid or mixtures of two or more thereof. Suitable as tricarboxylic acids are preferably citric acid or trimellitic acid. The acids mentioned may be used either individually or as mixtures of two or more thereof. Such OH-functional polyesters are known to a person skilled in the art and are commercially available. Particularly suitable are polyester polyols including two or three terminal OH groups.

Polyester polyols that are particularly suitable for the production of hot-melt adhesives are liquid, amorphous or crystalline copolyesters or the mixtures thereof; such polyester polyols are supplied for example under the name Dynacoll by Evonik Industries AG. These polyester polyols preferably have a hydroxyl number (determined according to DIN 53240-2:2007-11) between 10 and 200 mg KOH/g and an acid number (determined according to DIN EN ISO 2114 Correction 1:2006-11) which is smaller than or equal to 4, preferably smaller than or equal to 2 mg KOH/g.

Polyols from recycled polyethylene terephthalates that may be used according to the invention have been commercially available for some time. They are produced by way of glycolysis with low molecular weight glycols and by transesterification with dicarboxylic acids or dicarboxylic acid anhydrides from PET production residues. Another possibility is the use of recycled PET from pre-used PET materials. Methods for producing such polyols from PET production residues or PET from pre-used PET materials are described for example in documents U.S. Pat. No. 4,469,824, U.S. Pat. No. 4,568,717 A, WO2010015642 A1, EP1178062 A1, JP-A-2000-191756 or JP-A-02-011625.

Suitable recycled polyethylene terephthalate polyols have a hydroxyl number between 40 and 300 mg KOH/g and an acid number of smaller than 1.0 mg KOH/g, preferably smaller than 0.5 mg KOH/g. Preferably, they have a water content of less than 0.1% by weight and an OH functionality of 1.8 to 2.1.

Suitable polyisocyanates may be selected from the group of 1,5-naphthylene diisocyanate, 4,4′-diphenylmethane diisocyanate (MDI), 2,4′-diphenylmethane diisocyanate, 2,2′-diphenylmethane diisocyanate, hydrogenated or partially hydrogenated MDI (H12MDI, H6MDI), xylylene diisocyanate (XDI), tetramethyl xylylene diisocyanate (TMXDI), di- and tetraalkylene diphenylmethane diisocyanate, 4,4′-dibenzyl diisocyanate, 1,3-phenylene diisocyanate, 1,4-phenylene diisocyanate, the isomers of toluylene diisocyanate (TDI), 1-methyl-2,4-diisocyanato-cyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), chlorinated and brominated diisocyanates, phosphorous diisocyanates, tetramethoxybutane-1,4-diisocyanate, naphthalene-1,5-diisocyanate (NDI), butane-1,4-diisocyanate, hexane-1,6-diisocyanate (HDI), dicyclohexylmethane diisocyanate, tetramethylene-, hexamethylene-, undecane-, dodecamethylene-, 2,2,4-trimethylhexane-2,3,3-trimethyl-hexamethylene diisocyanate, cyclohexane-1,4-diisocyanate, ethylene-diisocyanate, methylene triphenyl triisocyanate (MIT), phthalic acid-bis-isocyanato-ethyl ester, diisocyanates with reactive halogen atoms, such as 1-chloro-methylphenyl-2,4-diisocyanate, 1-bromomethyl-phenyl-2,6-diisocyanate, 3,3-bis-chloro-methylether-4,4′-diphenyl diisocyanate. Further usable diisocyanates are trimethyl hexamethylene diisocyanate, 1,4-diisocyanato-butane, 1,12-diisocyanato-dodecane and dimer fatty acid diisocyanate, lysine diisocyanate, 4,4-dicyclohexylmethane diisocyanate, 1,3-cyclohexane or 1,4-cyclohexane diisocyanate.

Further suitable isocyanates are high molecular weight diisocyanates with a low monomeric diisocyanate content. In a first step, the diol component with an average molecular weight (number average MN determined according to DIN 55672-1:2007-08) of less than 2000 g/mol, in particular less than 1500 g/mol, is reacted with a large stoichiometric excess of a monomeric diisocyanate with a molecular weight of less than 500 g/mol to form a high molecular weight diisocyanate. After this reaction, the high molecular weight diisocyanate is, optionally by adding a non-solvent, precipitated from the reaction mixture and is freed from any non-reacted diisocyanate by filtration or centrifugation. The production of such high molecular diisocyanates is described for example in document EP1237971 A1.

Particularly suitable for the production of reactive hot-melt adhesives are polyisocyanates selected from 4,4′-diphenylmethane diisocyanate, 2,4′-diphenylmethane diisocyanate, 2,2′-diphenylmethane diisocyanate, a mixture of the isomers with or without the higher functional homologues thereof, as well as the above-mentioned high molecular weight diisocyanates.

Particularly preferred polyurethane compositions are characterised in that the prepolymer(s) has/have a monomeric diisocyanate content of less than 5% by weight, preferably less than 1% by weight, particularly preferably less than 0.5% by weight.

The individual polyols may be reacted separately with the respective diisocyanate and may then be appropriately mixed in a subsequent step. However, in many cases it is more economical to mix the polyols to be used in advance at an appropriate ratio and subsequently to react this mixture with the diisocyanate compound.

As catalysts, all the known compounds may be used that can catalyse isocyanate reactions. Examples of these are titanates such as tetrabutyl titanate and tetrapropyl titanate, tin carboxylates such as dibutyl tin dilaurate (DBTL), dibutyl tin diacetate, tin octoate; tin oxides such as dibutyl tin oxide and dioctyl tin oxide; organoaluminium compounds such as aluminium tris acetyl acetonate, aluminium tris ethyl acetoacetate; chelate compounds such as titanium tetra acetyl acetonate; amine compounds such as triethylene diamine, guanidine, diphenylguanidine, 2,4,6-tris(dimethylaminomethyl)phenol, morpholine, N-methyl morpholine, 2-ethyl-4-methyl imidazole and 1,8-diazabicyclo-(5,4,0)-undecene-7 (DBU), 1,4-diazabicyclo[2,2,2]octane, N,N-dimethyl piperazine, 1,8-diazabicyclo[5.4.0]undec-7-ene, dimorpholino-dimethyl ether, dimorpholino-diethyl ether (DMDEE) or the mixtures thereof. The catalysts are preferably used in an amount of 0.01 to approx. 5% by weight in relation to the overall weight of the composition.

As tackifying resins, for example abietic acid, abietic acid ester, terpene resins, terpene phenol resins, phenol-modified styrene polymers, phenol-modified a-methyl styrene polymers or hydrocarbon resins, tall oil resins, colophonium resins, pentaerythritol colophonium resins or aromatically modified hydrocarbon resins may be used. These will then be used in amounts between 5 and 30% by weight.

In special compositions, in particular also plasticisers may be added. These are non-reactive plasticisers, for example naphthenic mineral oils, polypropylene, polybutene, polyisobutylene, polyisoprene oligomers, hydrogenated polyisoprene and/or polybutadiene oligomers, benzoate esters, phthalates, adipates or hydrocarbon oils.

Pigments and fillers may also be contained in small amounts.

If required, preferably organofunctional silanes such as hydroxy-functional, (meth)acryloxy-functional, mercapto-functional, amino-functional or epoxy-functional silanes may be used as adhesion promoters. The amounts may be in the range of 0 to 10% by weight, preferably 0 to 5% by weight, in relation to the mixture.

As stabilisers, for example antioxidants may be used, such as the commercially available sterically hindered phenols and/or thioethers and/or substituted benzotriazoles or the sterically hindered amines of the HALS type. Such stabilisers are sold for example under the designation Irganox by BASF.

A further embodiment of the invention may contain as additives also proportions of other polymers without further functional groups. These may be synthetic polymers which influence properties important for example for hot-melt adhesives, such as adhesion, strength and temperature behaviour. Such polymers may for example be polycondensates, such as (co)polyamides, polyamide/EVA copolymers, polyether amides, polyether ester amides; polymerisates such as polyvinyl pyrrolidone, polyethyloxazoline, polyvinyl methyl ether, ethylene, ethylene/vinyl acetate, ethylene/acrylate, propylene, (meth)acrylate copolymers. Further, substantially amorphous polyolefins such as atactic polypropylene, atactic poly-1-butene, ethene-propene copolymers, ethene-1-butene copolymers, ethene-propene-1-butene terpolymers, propene-1-butene copolymers, ethene-propene-1-hexene terpolymers, ethene-propene-1-octene terpolymers, ethene-1-butene-1-hexene terpolymers, ethene-1-butene-1-octene terpolymers, ethene-1-hexene-1-octene terpolymers, propene-1-butene-1-hexene terpolymers, propene-1-butene-1-octene terpolymers or propene-1-hexene-1-octene terpolymers may be used. Particularly suitable are polymers from the group of poly(meth)acrylates and the copolymers thereof. These are for example copolymers of ethylenically unsaturated compounds, such as Cl to C18 alkyl esters of (meth)acrylic acid, (meth)acrylic acid, ester of (meth)acrylic acid with glycol ethers, such as methoxyethanol and/or ethoxyethanol, vinyl esters such as vinyl acetate, vinyl propionate, vinyl esters of branched monocarboxylic acids. Such (meth)acrylates should in particular have an average molecular weight (MN) of less than 60,000 g/mol, in particular of 10,000 to 40,000 g/mol. Such further polymers may be contained in amounts of 0 to 20% by weight, in particular of 5 to 15% by weight. Altogether, less than 25% by weight of additives should be contained in the adhesive.

A particularly preferred use of the polyurethane compositions according to the invention are reactive one-component adhesives or hot-melt adhesives, as will be explained in more detail in the following examples. The viscosities were determined using a rotation viscometer of the type Brookfield DV II+using spindle 27 at 5 rpm.

### EXAMPLE 1

### According to the Invention

A one-component hot-melt adhesive is formulated using the following basic composition (data in percent by weight):
21.18% of Dynacoll 7130
12.70% of PET Polyol, OH number: 65, viscosity at 70° C.: 3350 mPa*s (PETOPUROL 70, PETOPUR GmbH Schwarzheide)
25.32% of Dynacoll 7360
25.32% of Dynacoll 7380
15.28% of Desmodur 44M (4,4′-diphenylmethane diisocyanate (MDI), Bayer)
0.2% of Irganox 1010

The polyester polyols are initially placed in a glass flask and melted at 130° C. Subsequently, a vacuum of <50 mbar is applied, and the mixture is dried for 1.5 h under stirring. The vacuum is stopped with nitrogen and Desmodur 44M is added. Vacuum is applied and the temperature is kept at 123° C.-130° C. The reaction time is 45 minutes.
Viscosity at 130° C.: 22,000 mPa*s
After 16 h at 130° C.: 61,000 mPa*s
Increase in viscosity: 177%

### COMPARATIVE EXAMPLE 2

### Not Inventive

A hot-melt adhesive is formulated using the following basic composition (data in percent by weight):
21.18% of Dynacoll 7130
11.70% of Sovermol 1005 (BASF)
25.32% of Dynacoll 7360
25.32% of Dynacoll 7380
16.28% of Desmodur 44M
0.2% of Irganox 1010 (stabiliser, BASF)

Production as per Example 1
Viscosity at 130° C.: 25,000 mPa*s
After 16 h at 130° C.: 253,000 mPa*s
Increase in viscosity: 912%

### EXAMPLE 3

### According to the Invention

A one-component adhesive is formulated using the following basic composition (data in percent by weight):
19.45% of Desmodur VKS 20 (a mixture of diphenylmethane-4,4′-diisocyanate (MDI) with isomers and higher-functional homologues (PMDI), Bayer)
24.80% of Desmodur 44M
25.00% of polypropylene glycol 2000
30.45% of PET Polyol, OH number: 65, viscosity at 70° C.: 3350 mPa*s (PETOPUROL 70, PETOPUR GmbH Schwarzheide)
0.20% of DMDEE

The isocyanates are placed in a glass flask under stirring and are heated to 70° C. Subsequently, the polyols are added and are allowed to react for 30 min at 70° C. Subsequently, DMDEE is added and is allowed to homogenise for 10 min.
Viscosity at 20° C.: 45,100 mPa*s
After 4 weeks at 40° C.: 52,300 mPa*s (measured at 20° C.)
Increase in viscosity: 16%

### COMPARATIVE EXAMPLE 4

### Not Inventive

A one-component adhesive is formulated using the following basic composition (data in percent by weight)
19.45% of Desmodur VKS 20
24.80% of Desmodur 44M
25.00% of polypropylene glycol 2000
30.45% of Renuva DWD 2007.01 (Dow)
0.20% of DMDEE

Production as per Example 3
Viscosity at 20° C.: 28,800 mPa*s
After 4 weeks at 40° C.: 82,300 mPa*s (measured at 20° C.)
Increase in viscosity: 186%

It is clear from the above examples that only the compositions according to the invention, which contained the PET polyols as sustainable component, had sufficient viscosity stability.

What is claimed is:

1. A solvent-free, moisture-curing polyurethane composition, wherein the composition contains the following components:
a) 99.9 to 75% by weight of at least one polyurethane prepolymer with free isocyanate groups, produced by reacting at least one polyol, selected from the group of the polyether polyols and polyester polyols, with at least one polyisocyanate in a stoichiometric excess, wherein at least one polyol is a recycled polyethylene terephthalate polyol, and
b) 0.1 to 25% by weight of at least one additive selected from the group of catalysts, resins, plasticisers, fillers, pigments, stabilisers, adhesion promoters and further polymers, wherein the sum of a) and b) results in 100% by weight.

2. A polyurethane composition according to claim 1, wherein polypropylene glycols, polytetramethylene glycols and/or statistic copolymers and/or block copolymers of ethylene oxide and propylene oxide are used as polyether polyols.

3. A polyurethane composition according to claim 1, wherein liquid, amorphous or crystalline copolyesters are used as polyester polyols.

4. A polyurethane composition according to claim 1, wherein the recycled polyethylene terephthalate was produced by glycolisation of polyethylene terephthalate waste or by transesterification of polyethylene terephthalate waste with dicarboxylic acids.

5. A polyurethane composition according to claim 4, wherein the recycled polyethylene terephthalate polyol has a hydroxyl number between 40 and 300 mg KOH/g and an acid number smaller than 1.0 mg KOH/g, preferably smaller than 0.5 mg KOH/g.

6. A polyurethane composition according to claim 1, wherein liquid, amorphous or crystalline copolyesters having a hydroxyl number between 10 and 200 mg KOH/g are used as polyester polyols.

7. A polyurethane composition according to claim 1, wherein the polyether polyol(s) has/have a hydroxyl number between 20 and 500 mg KOH/g.

8. A polyurethane composition according to claim 1, wherein the polyisocyanate is selected from diphenylmethane-4,4′-diisocyanate, diphenylmethane-2,4′-diisocyanate or a mixture of the isomers with or without the higher functional homologues thereof.

9. A polyurethane composition according to claim 1, wherein the prepolymer has a monomeric diisocyanate content of less than 5% by weight, preferably less than 1% by weight, particularly preferably less than 0.5% by weight.

10. A polyurethane composition according to claim 1, wherein the prepolymer has a monomeric diisocyanate content of less than 0.5% by weight.

11. A polyurethane composition according to claim 1, wherein the polyether polyols are diols with hydroxyl numbers between 20 and 500 mg KOH/g.

12. A polyurethane composition according to claim 1, wherein none of the polyols is a polyether polyol.

13. A one-component adhesive, reactive hot-melt adhesive, coating material or sealant comprising the polyurethane composition according to claim 1.
